(19) United States
(12) Patent Application Publication
(10) Pub. No.: US 2003/0210371 A1
(43) Pub. Date: Nov. 13, 2003

(54) System and method for extending light valve lifetime in liquid crystal display devices

(75) Inventors: Praveen Chaudhari, Briarcliff Manor, NY (US); Fuad E. Doany, Katonah, NY (US); James P. Doyle, Bronx, NY (US); James H. Glownia, Somers, NY (US); Minhua Lu, Mohegan Lake, NY (US); Alan E. Rosenbluth, Yorktown Heights, NY (US)

Correspondence Address: Frank Chau, F. CHAU & ASSOCIATES, LLP, Suite 501, 1900 Hempstead Turnpike, East Meadow, NY, 11554, US

(73) Assignee: International Business Machines Corporation, Armonk, NY

(21) Appl. No.: 10/140,598

(22) Filed: May 7, 2002

(51) Int. Cl. G02F 1/1335

(52) U.S. Cl. 349/124

(57) ABSTRACT

A liquid crystal display system comprises a lamp providing illumination, a beam splitter for redirecting the illumination, and a light valve comprising an ion beam treated diamond like carbon inorganic film deposited over the substrate, wherein the inorganic film is patterned asymmetrically, having surface carbon atoms forming ridges for aligning liquid crystal, wherein the light valve reflects an illumination through the redirecting beam splitter. The system further comprises a violet-blocking long-pass filter positioned between the lamp and the beam splitter, and a short-pass trim filter positioned between the lamp and the beam splitter.

### BACKGROUND OF THE INVENTION

1. Field of the Invention

The present invention relates to liquid crystal alignment layers, and more particularly, to a system and method for aligning liquid crystals and filtering a lamp spectrum such that light valve lifetime can be increased.

2. Discussion of the Related Art

A liquid crystal display is an electro-optical device that utilizes the birefringence effect of liquid crystals. The birefringence of a liquid crystal changes when the orientation of liquid crystal molecules change in response to external electrical fields. Therefore, the control of the orientation of the liquid crystal molecules is important to the device performance. Device performance can be measured as contrast ratio, color, viewing angle, switch speed etc.

Liquid crystal alignment can be described as homogeneous or homeotropic. Homogeneous alignment describes liquid crystals aligned in parallel in a plane of a substrate. Homeotropic alignment describes liquid crystal molecules perpendicular to the plane of the substrate. Homogeneous alignment can be produced by rubbing polyimide film with cloth. Homogenous alignment has been proven to be a relatively low cost high yield and high throughput process, and gives reasonable performance and reliability for most direct-view applications. However, the rubbing process is not a precise means for achieving alignment. Issues, such as how the rubbing affects the polyimide film, how the polyimide affects the orientation of the liquid crystal molecules, how to control the alignment anchoring strength and improve reliability, do not have ready answers. Cloth-fiber particles and polyimide flakes can be produced during rubbing, which can affect the alignment quality. Electrostatic discharge generated by the rubbing can damage thin-film transistor (TFT) circuits on the substrate, resulting in lower yield.

With the liquid crystal display applications expanding to new markets such as home theater, such problems are becoming more pronounced. Non-rubbing alignment methods have been an active research topic in the liquid crystal display industry. For example, IBM has announced a method of using ion beam treated diamond like carbon (DLC) films to produce homogeneous alignment with high front of screen quality. Different from the polyimide rubbing process, for IB alignment, the polymer layer is replaced by very thin DLC film and the rubbing wheel is replaced by a collimated low energy ion beam. Accordingly, the alignment process and quality have been improved substantially.

However, for liquid crystal light valves used in projection applications, the light valves need to be stable under prolonged and intense photo illumination. Failure of the liquid crystal light valves under intense light has become a hurdle in meeting the rising standards of the projection market.

Lu et al. reported that the failure of the liquid crystal light valve is due to degradation of the surface of the alignment layer. Under photo irradiation, auto oxidation is accelerated, stray oxygen in the liquid crystal cell can be absorbed to polyimide (PI) and pretilt angles can decrease, degrading the quality of the LCD device. Further irradiation can cause a radical reaction between the liquid crystal and polyimide, and result in liquid crystal attachment on the PI surface. When the liquid crystal attachment reaches a certain threshold, the alignment changes from homogenous to homeotropic. As a result, the display is no longer functional.

Liquid crystal displays that use rubbed polyimide alignment or diamond-like-carbon (DLC) ion-beam (IB) alignment are typically unstable under high dose photo irradiation. The pretilt angle of liquid crystal on a photoaligning surface can depend on violet and ultraviolet exposure. Under sustained light exposure, as from projection display illuminators, the pretilt angle of the liquid crystal alignment can change from homogeneous to homeotropic, degrading the quality of a liquid crystal device. Therefore, a photostable liquid crystal alignment is an important issue faced by liquid crystal projector manufacturers, and is important to the success of the liquid crystal projection industry.

Many liquid crystal light valves are unstable under sustained illumination by projector light sources, limiting light valve lifetime. Such light valves are increasingly used in the rapidly growing projection display market. The lifetime limitations of light valves may become more apparent as technology trends in the industry require light valves to endure increased flux concentrations. These trends include the need for increased brightness, the need for long lifetime and low maintenance light valves such as those used in consumer applications like projection televisions, and a shift to smaller, cheaper, light values, needing greater concentrations of illumination.

Referring to FIG. 1, a light valve can include, for example, a liquid crystal layer 101, a mirror 102, a photoconductor layer 103 and transparent electrode layers 104-105. A light valve can be a transmissive or reflective liquid crystal device with active matrix backplane without photoconductor layer.

An important factor limiting light valve lifetime is an interaction between the liquid crystals and bounding alignment layers; this interaction can arise in the presence of short wavelength light. For safety reasons, UV light can be filtered from the spectra of projection lamps, but lifetime is still limited by residual absorption at violet wavelengths, for example, wavelengths between 390 nm and 440 nm. These wavelengths are within the visible spectrum and therefore, may be perceived by viewers. The wavelength of peak sensitivity for the blue receptors of the eye is about 440 nm. The sensitivity at 400 nm is about ⅙ of peak. Violet wavelengths thus make a perceptible contribution to overall blue channel chromaticity.

Therefore, a need exists for a system and method of increasing light valve lifetime.

### SUMMARY OF THE INVENTION

According to an embodiment of the present invention, a method is provided for inorganic alignment of liquid crystal. The method comprises providing a substrate, depositing a layer of inorganic film on the substrate, wherein the film has a low ultraviolet absorption, exposing the film to an ion beam, and selectively removing atoms exposed to the ion beam, creating an asymmetrical pattern in the inorganic layer.

The ion beam has an angle of incidence relative to the inorganic film of between about 10 degrees and about 85 degrees.

The inorganic film has a low UV absorption. The inorganic film is one of diamond like carbon, C₂N₂, SiNₓ , SiO₂, AL₂O₃, and Ti₂O₃.

The method comprises exposing the film to an ionizable gas. The ionizable gas is one of a Nitrogen ion beam, an Argon ion beam, an oxygen ion beam and a Hydrogen ion beam.

The alignment of liquid crystal by ion beam treated inorganic film can be one of tilted homeotropic and tilted homogeneous, the pretilt angle being between about 0 to 10 degrees from substrate for homogeneous alignment and about 0 to 10 degrees from substrate normal for homeotropic alignment.

The method further comprises filtering violet wavelengths from a spectrum illuminating the inorganic film. The inorganic film is incorporated in a blue-channel light valve.

The method comprises filtering a spectrum illuminating the inorganic film with a short-pass trim filter.

The asymmetrical pattern aligns liquid crystal unidirectionally.

According to an embodiment of the present invention, a liquid crystal projection display system comprises a lamp providing illumination, a beam splitter for redirecting the illumination, and a light valve comprising an inorganic film deposited over the substrate, wherein inorganic film asymmetry is produced by ion beam irradiation for aligning liquid crystal, wherein the light valve reflects an illumination through the beam splitter. The display system further comprises a violet-blocking long-pass filter positioned between the lamp and the beam splitter, and a short-pass trim filter positioned between the lamp and the beam splitter.

The lamp is an arc lamp.

The light valve is a blue-channel light valve.

The violet-blocking long-pass filter has a cutoff wavelength within the range of about 400 nanometers to about 450 nanometers.

The short-pass trim filter has a cutoff wavelength within the range of about 475 nanometers to about 515 nanometers.

The violet-blocking long-pass filter has a cutoff wavelength of about 435 nanometers and the short-pass trim filter has a cutoff wavelength of about 489 nanometers.

### BRIEF DESCRIPTION OF THE FIGURES

Preferred embodiments of the present invention will be described below in more detail, with reference to the accompanying drawings:

FIG. 1 is a diagram of a light valve;

FIG. 2 is a diagram of an ion beam striking a thin film;

FIG. 3 is a flow chart of a method according to an embodiment of the present invention.

FIG. 4 is a graph of flux versus wavelength according to an embodiment of the present invention;

FIG. 5 is a diagram of a projection display system according to an embodiment of the present invention;

FIG. 6 is a table showing a relationship between blue-channel luminosity and lifetime extension according to an embodiment of the present invention.

### DETAILED DESCRIPTION OF PREFERRED EMBODIMENTS

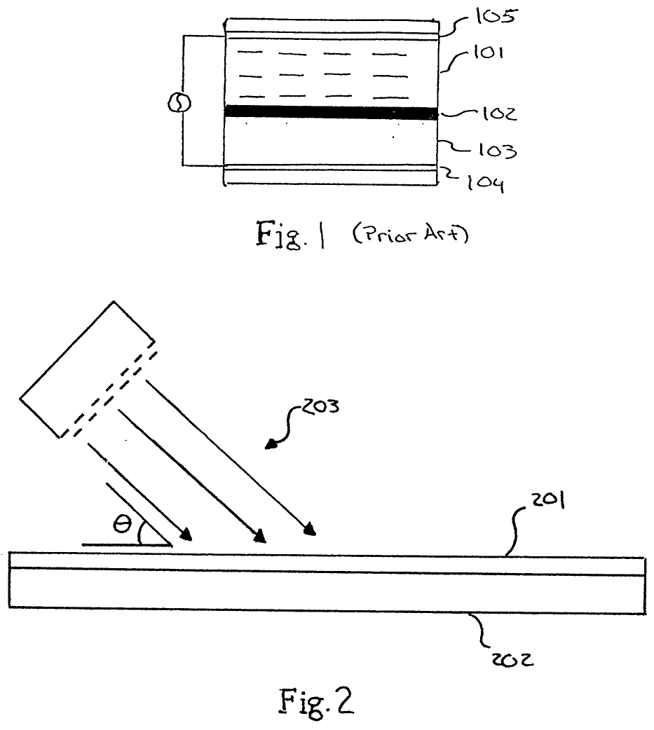

According to an embodiment of the present invention, liquid crystals can be aligned by a thin layer of inorganic film, such as DLC, treated with an ion beam (IB). The inorganic film can be, for example, 10-500A in thickness. Referring to FIG. 2, using a thin film process such as PECVD, CVD, sputter, evaporation, etc., the layer of inorganic film 201 can be deposited over a substrate 202. The substrate can be, for example, glass or Silicon wafer. The film can be exposed to an IB 203, for example a Nitrogen IB or Argon IB. The angle θ of the beam 203 to the surface of the thin film 201, and the beam dosage effects the surface of the thin film 201, selectively removing surface carbon atoms and forming a pattern. The angle of incidence can be about 10 degrees to about 85 degrees. The pattern is asymmetrical and can be used to align a layer of liquid crystal unidirectionally.

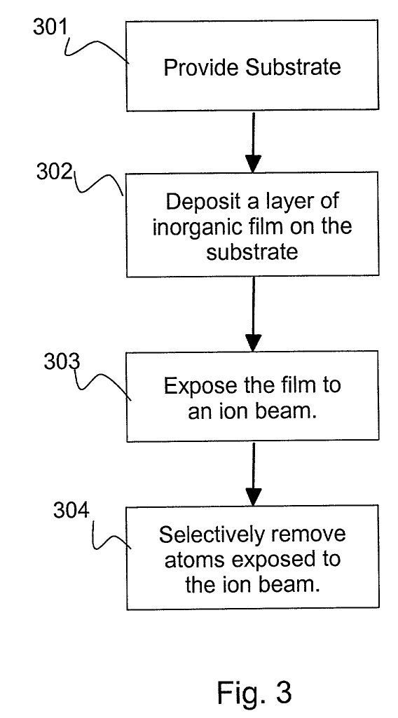

Referring to FIG. 3, a method for inorganic alignment of liquid crystal displays with high photostability comprises providing a substrate 301, depositing a layer of inorganic film on the substrate 302, wherein the film has a low ultraviolet absorption, exposing the film to an ion beam 303, and selectively removing atoms exposed to the ion beam, creating an asymmetrical pattern in the inorganic layer 304.

To obtain good photo-stability, the inorganic film material needs to have little or no UV absorption, for example, DLC, C₂N₂, SiNₓ, SiO₂, AL₂O₃, and Ti₂O₃. For example, the fractional absorption in SiO₂ has been measured as low as about 3.7E-4 per micron even at the UV wavelength of about 159 nm. For SiN, absorption has been measured at 1% per micron at 275 nm. The IB treatment can be controlled so that the film composition does not substantially change. The film composition can relate to the UV transparency of the film.

The surface of the inorganic film, having a high surface energy, is in homogeneous alignment when in contact with liquid crystal. The surface of the inorganic film should not promote radical reaction with the liquid crystal molecules under UV irradiation, so that the liquid crystal molecules will not attach to the surface of the film.

For example, SiN or SiO₂ films are UV transparent. If the IB removes Nitrogen or Oxygen from the film, excess silicon will remain that can absorb short wavelengths. A Nitrogen IB or Oxygen IB can be used to compensate for the loss of the Nitrogen or Oxygen to maintain the UV transparency or film composition. In addition, van der Waals interactions between the film and the liquid crystal tend to pull liquid crystal molecules with positive dielectric anisotropy towards the surface in a homogeneous alignment. The homogeneous alignment is stable where there is little or no possibility of inducing a radical reaction between the surface and the liquid crystal. Experiments have shown an increase in the lifetime to at least two or three times the life time of the best known polyimide.

Surface modification of a DLC IB film (or other inorganic IB-treated film) to saturate the dangling bonds, can extend the life time of a liquid crystal device as well. Surface modification of DLC films includes those DLC films with N₂H₂ atoms.

According to an embodiment of the present invention, the lifetime of an IB-treated inorganic alignment layer, such as that described above, can be further increased by filtering a spectrum used for illumination in, for example, projectors. The cumulative lamp exposure which a light valve can endure, as measured by the accumulated Joules/cm² at failure, decreases exponentially with photon frequency in the visible region. For example, tests have shown that a sample IBM light valve made using IB-treated SiN alignment layers will no longer respond satisfactorily after an exposure dose given by:

Allowable Joules/cm²=Exp(A[(1/W0)−(1/W)])

where A=11558.9 nm and W0=269.57 nm, with W denoting the illumination wavelength in nanometers, and Exp(z) denoting e=2.718 to the power z. At violet and blue wavelengths, the survivable dose can decrease rapidly as photon energy increases. The failure criterion used here is a relatively conservative one, in which an excessively disturbed response becomes distinctly visible in the blue channel at intermediate gray levels. The changed response can be noticed in pixels surrounding the spacer posts, and corresponds to a change in pretilt angle of about two degrees. At larger doses the pretilt angle begins a rapid increase, and the light valve fails catastrophically. The coefficient A and WO can be determined by exposing sample light valves to high intensity probe beams of different spectral content.

In a typical projector, the beam that illuminates the blue channel light valve includes radiation between about 400 nm and about 520 nm, with predominant intensities in the wavelengths between about 430 nm and about 485 nm. (In color-sequential projectors one or two light valves are periodically illuminated with such a blue-band spectrum.) The hue of the blue primary approximates that of a 465 nm light, with a lower saturation. The spectral intensity decreases at longer and shorter wavelengths; this falloff can be gradual at the short end, due to attenuation from, e.g., polarizers and high-index glasses.

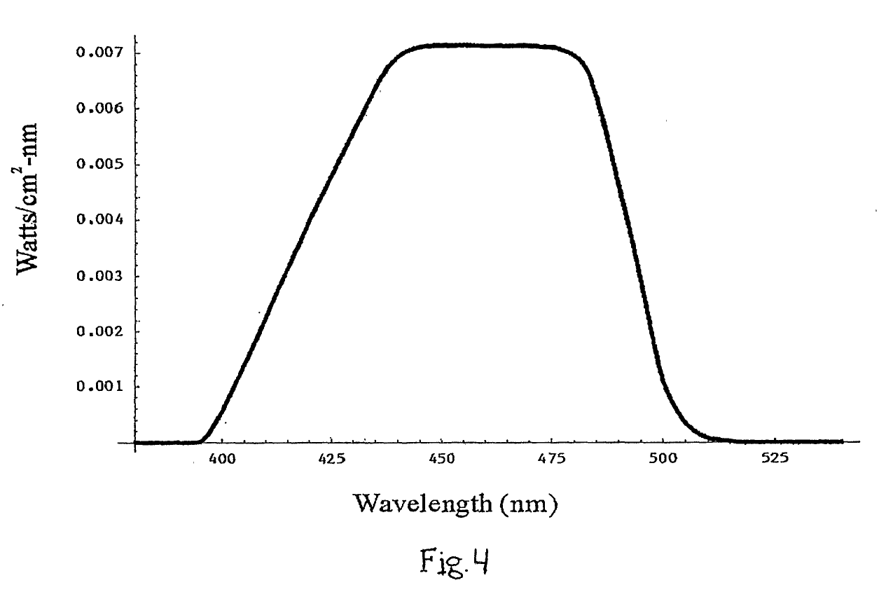

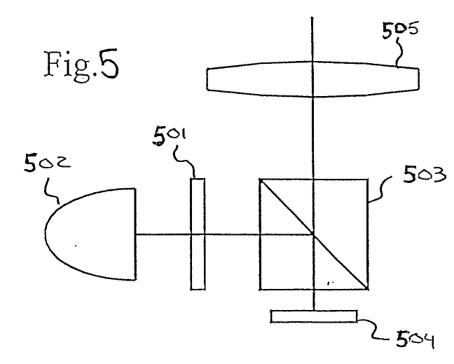

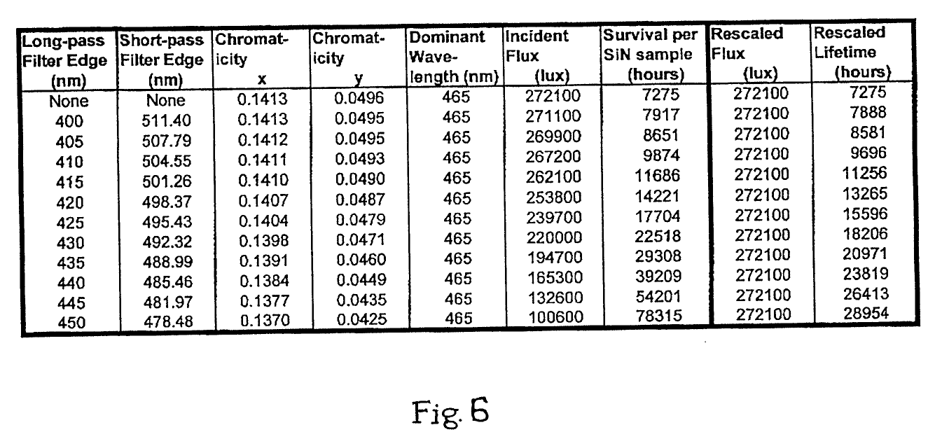

FIG. 4 illustrates a spectrum illuminating the blue-channel light valve in a projector that uses an arc lamp source, in this case a Xenon (Xe) lamp. At the fluxes shown, the projector can provide about 1000 lumens of white light on-screen if the light valves have an area of 5 cm². Total blue-band illumination on the light valve is 272000 lux, and the blue-channel chromaticity is x=0.141, y=0.050. Color shifts arising from the light valve response, and from the upstream optical components which project the bright-state image light can be ignored for simplicity. This chromaticity corresponds to a dominant wavelength of 465 nm if the white point is 8200 deg-K, which approximately matches the Society of Motion Picture and Television Engineers standard for blue-channel hue in color televisions, SMPTE-C.

According to the above formula for dose-to-failure, light valve lifetime with this spectrum is about 7300 hours. The light value lifetime is approximately ninety percent longer than can be obtained from a long-lived polyimide, such as JSR's AL3046 formulation. However, in many applications a lifetime of 10,000 hours or more may be needed. Because of the highly nonlinear dependence of pretilt change on wavelength, valve lifetime can be extended substantially by filtering shorter wavelengths from the spectrum (FIG. 4).

Referring to FIG. 5, a filter 501 is placed between the lamp 502 and a beam splitter 503. A light valve 504 reflects the filtered beam through the lens 505.

A violet-cut filter can shift the hue of the blue primary to longer wavelengths. However, shifting the hue can introduce color distortion, despite the low luminosity of the trimmed wavelengths. Thus, the violet-blocking long-pass filter can be combined with a short-pass trim filter. The combined filter can decrease blue-channel luminosity. In many cases luminosity is not an issue since the blue channel needs to be trimmed in some cases to provide the desired white point (typically for reasons unrelated to violet-blocking). However, if (after filtering) the projector color of the blue channel gates balance, the intensity may need to be reduced, or the illuminator may need to be re-engineered to restore the lost blue luminosity. A suitable violet filter can provide substantial lifetime increases by reducing the potential interaction between the liquid crystal and the bounding layers with only a modest reduction in blue-channel brightness. Moreover, even if the total illuminating power is restored to its previous level (by redesign of the illuminator), blue-channel lifetime can still be increased by a substantial factor.

FIG. 5 illustrates how blue-channel luminosity and lifetime extension tradeoff one another using the FIG. 3 spectrum, as an example. Each filter entry in the table provides a dominant wavelength of 465 nm (for 8200 deg-K white point), minimizing color distortions.

Projector lifetime will often be gated by blue channel survival, due to the strong dependence of alignment degradation on wavelength. This applies to projectors that contain at least one light valve that does not see blue light, as is often the case. Thus, the present invention can be deployed only in the blue channel if desired.

Having described preferred embodiments of a system and method of increasing light valve lifetime, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A method for inorganic alignment of liquid crystal comprising the steps of:
providing a substrate;
depositing a layer of inorganic film on the substrate, wherein the film has a low ultraviolet absorption;
exposing the film to an ion beam; and
selectively removing atoms exposed to the ion beam, creating an asymmetrical pattern in the inorganic layer.

2. The method of claim 1, wherein the ion beam has an angle of incidence relative to the inorganic film of between about 10 degrees and about 85 degrees.

3. The method of claim 1, wherein the inorganic film has a low UV absorption.

4. The method of claim 1, wherein the inorganic film is one of diamond like carbon, C₂N₂, SiNₓ, SiO₂, AL₂O₃, and Ti₂O₃.

5. The method of claim 1, further comprising the step of exposing the film to an ionizable gas.

6. The method of claim 5, wherein the ionizable gas is one of a Nitrogen ion beam, an Argon ion beam, an Oxygen ion beam and a Hydrogen ion beam.

7. The method of claim 1, wherein the alignment of liquid crystal by ion beam treated inorganic film can be one of tilted homeotropic and tilted homogeneous, the pretilt angle being between about 0 to 10 degrees from substrate for homogeneous alignment and about 0 to 10 degrees from substrate normal for homeotropic alignment.

8. The method of claim 1, further comprising the step of filtering violet wavelengths from a spectrum illuminating the inorganic film.

9. The method of claim 8, wherein the inorganic film is incorporated in a blue-channel light valve.

10. The method of claim 1, further comprising filtering a spectrum illuminating the inorganic film with a short-pass trim filter.

11. The method of claim 1, wherein the asymmetrical pattern aligns a liquid crystal unidirectionally.

12. A liquid crystal projection display system comprising:
a lamp providing illumination;
a beam splitter for redirecting the illumination;
a light valve comprising an inorganic film deposited over the substrate, wherein inorganic film asymmetry is produced by ion beam irradiation for aligning liquid crystal, wherein the light valve reflects an illumination through the beam splitter;
a violet-blocking long-pass filter positioned between the lamp and the beam splitter; and
a short-pass trim filter positioned between the lamp and the beam splitter.

13. The system of claim 12, wherein the lamp is an arc lamp.

14. The system of claim 12, wherein the light valve is a blue-channel light valve.

15. The system of claim 12, wherein the violet-blocking long-pass filter has a cutoff wavelength within the range of about 400 nanometers to about 450 nanometers.

16. The system of claim 12, wherein the short-pass trim filter has a cutoff wavelength within the range of about 475 nanometers to about 515 nanometers.

17. The system of claim 12, wherein the violet-blocking long-pass filter has a cutoff wavelength of about 435 nanometers and the short-pass trim filter has a cutoff wavelength of about 489 nanometers.
